(19) United States
(12) Patent Application Publication
(10) Pub. No.: US 2020/0240327 A1
(43) Pub. Date: Jul. 30, 2020

(54) GAS TURBINE ENGINE WITH POWER TURBINE DRIVEN BOOST COMPRESSOR

(71) Applicant: PRATT & WHITNEY CANADA CORP., Longueuil (CA)

(72) Inventors: David MENHEERE, Norval (CA); Timothy REDFORD, Cambellville (CA); Daniel VAN DEN ENDE, Mississauga (CA); Santo CHIAPPETTA, Georgetown (CA)

(21) Appl. No.: 16/256,123

(22) Filed: Jan. 24, 2019

(51) Int. Cl. F02C 3/10; F02C 6/08

(52) U.S. Cl. CPC F02C 3/10; F02C 6/08

(57) ABSTRACT

A gas turbine engine has an output shaft, a power turbine drivingly engaged to the output shaft, a boost compressor drivingly engaged by the power turbine; and a boost compressor bleed air circuit having an inlet fluidly connected to the boost compressor and an outlet fluidly connected to the power turbine.

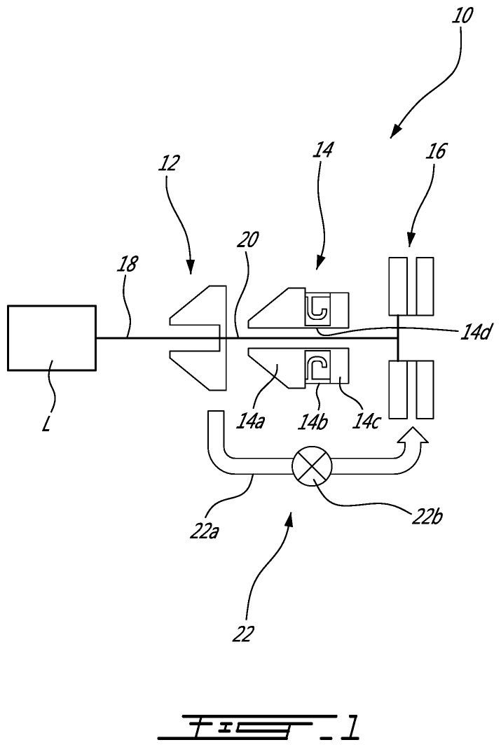

### TECHNICAL FIELD

The application relates generally to gas turbine engines and, more particularly, to engines with a power turbine driven boost compressor.

### BACKGROUND OF THE ART

Turbine engines use boost compressors to improve power. The boost compressor can either be driven by a separate shaft and a dedicated turbine or from the power turbine, which also drives the output shaft of the engine. In the latter configuration, the pressure ratio provided by the boost compressor is, thus, linked to the maximum capacity of the power turbine, and is therefore fixed. The fixed pressure ratio provided by the boost compressor limits the operation and efficiency of the gas turbine engine through all operating conditions.

### SUMMARY

In one aspect, there is provided a gas turbine engine has an output shaft, a power turbine drivingly engaged to the output shaft, a boost compressor drivingly engaged by the power turbine; and a boost compressor bleed air circuit having an inlet fluidly connected to the boost compressor and an outlet fluidly connected to the power turbine.

In another aspect, there is provided a turboshaft or turboprop engine comprising: an output shaft, a boost compressor; a power turbine drivingly connected to the output shaft and the boost compressor; a core including a high pressure turbine drivingly connected to a high pressure compressor, the high pressure compressor fluidly connected to the boost compressor for receiving pressurized air therefrom; and a boost compressor bleed air circuit fluidly connecting the boost compressor to the power turbine, the boost compressor bleed circuit allowing the core to be selectively bypassed.

In a further aspect, there is provided a method of operating a compressor section of a gas turbine engine having a boost compressor driven by a power turbine which also drives an output shaft of the engine, the method comprising: bleeding air from the boost compressor, and reinjecting the boost compressor bleed air into the power turbine.

### DESCRIPTION OF THE DRAWING

The FIGURE is a schematic cross-section view of a gas turbine engine with a power turbine driven boost compressor.

### DETAILED DESCRIPTION

With reference to the FIGURE, there is illustrated a schematic representation of one form of a turboprop or turboshaft gas turbine engine 10 of a type preferably provided for use in subsonic flight, the engine 10 having a power turbine driven boost configuration. More particularly, the engine 10 generally comprises a boost compressor 12 to supercharge a central core 14, thereby increasing the overall pressure ratio. The boost compressor 12 may be a single-stage device or a multiple-stage device and may be a centrifugal or axial device with one or more rotors having radial, axial or mixed flow blades.

According to a particular embodiment, the boost compressor 12 is driven by a power turbine 16, which also drives the engine output shaft 18 for driving a load L, such as propeller(s), helicopter main rotor(s) and/or tail rotor(s), pump(s), generator(s), or any other type of load or combination thereof. The power turbine 16 may comprise one or more stages drivingly connected to the boost compressor 12 via a low pressure shaft 20 extending along a centerline of the engine 10. In a particular embodiment, the boost compressor 12, the power turbine 16 and the low pressure shaft 20 form the low pressure (LP) spool of the engine 10.

The low pressure shaft 20 and the output shaft 18 can be integral or separate. A reduction gearbox (RGB) or any other suitable transmission (not shown) can be provided between the low pressure shaft 20 and the output shaft 18. The RGB allows for the load L (e.g. the propeller) to be driven at its optimal rotational speed, which is different from the rotational speed of the power turbine 16. Also, it is understood that the boost compressor 12 can be directly connected to the power turbine 16 via the low pressure shaft 20 or, alternatively, the boost compressor 12 can be geared via a second gearbox (not shown) to the power turbine 16, thereby allowing the boost compressor 12 to also run at a different rotational speed from the power turbine 12.

The core 14 is located downstream of the boost compressor 12 for receiving pressurized air from the boost compressor 12 and is configured to burn fuel at high pressure to provide energy. In a particular embodiment, the core 14 comprises in serial flow communication a high pressure compressor 14a, a combustor 14b and a high pressure turbine 14c. The high pressure turbine 14c is drivingly connected to the high pressure compressor 14a via a high pressure shaft 14d. The high pressure compressor 14a, the high pressure turbine 14c and the high pressure shaft 14d form a high pressure (HP) spool. The HP spool and the LP spool are independently rotatable about the centerline of the engine 10.

In operation, the air flow entry to the boost compressor 12 may be controlled using variable inlet guide vanes (VIGV) (not shown) disposed at an inlet of the boost compressor 12. The boost compressor 12 pressurizes the ambient air received from the VIGVs. The pressurized air is then directed from the boost compressor 12 to the high pressure compressor 14a. The high pressure compressor 14a further compresses the air before the pressurized air is mixed with fuel and ignited in the combustor 14b. The combustion gases discharged from the combustor 14b flow through the various stages of the high pressure turbine 14c where energy is extracted to drive the high pressure compressor 14a. The combustion gases flow from the high pressure turbine 14c to the power turbine 16 where energy is extracted to drive the boost compressor 12 and the output shaft 18 and, thus, the load L. The combustion gases are then discharged from the engine 10 via exhaust.

Contrary to turbofan applications, in turboshaft and turboprop applications, the low spool speed is not modulated with the power. Turboshaft and turboprop engines have constant speed output shafts, determined by the propeller, rotor or generator requirements. It is the constant speed of such applications which present a challenge for the connected boost rotor. The boost compressor in such configurations turns at a constant design speed at all engine conditions, which results in much of the operation at sub-optimal performance. The flow of the boost compressor at low engine power generates too much flow for the core. A current practice is, thus, to choke the flow into the boost compressor via the IGVs and bleed valves, which causes increased losses in the compressors, reduction in engine efficiency and control issues.

In the embodiment shown, instead of bleeding the boost flow to atmosphere, the boost compressor bleed air is injected back into the engine at a suitable pressure location. For instance, the engine 10 may further comprise a boost compressor bleed air circuit 22 including a duct 22a having an inlet fluidly connected to the boost compressor 12 and an outlet fluidly connected to one or more of the stages of the power turbine 16 to recover energy from the boost compressor air. The boost compressor bleed air circuit 22 thus defines a flow path between the boost compressor outlet and the power turbine 16 which is separate from the engine core 14. In a particular embodiment, the boost compressor bleed air circuit 22 comprises one or more diverting valves 22b configured to direct boost compressor air flow either to the core 14 or into the power turbine 16. The valve 22 could have a first position in which fluid flow through the boost compressor bleed air circuit 22 is prevented so that all the flow of pressurized air from the boost compressor 12 is directed into the core 14, and a second position wherein at least part of the air pressurized by the boost compressor is bled through the boost compressor bleed air circuit 22 so as to bypass the core 14 before being reinjected into the power turbine 16. Compressor surge margin can be managed with bleed extraction but the current techniques dump the unused bleed air overboard, wasting compressor work. The reinjection of the boost bleed air into the power turbine 16 would not recover all the compression energy but would recover a non-negligible amount to improve engine fuel specific consumption (SFC) at off-design conditions (e.g. low power conditions). This diverting of the flow also creates a variable cycle allowing the flow through the core of the engine to be tailored for optimum power or efficiency through the entire cycle. In some applications, this may allow the core 14 to be controlled to run closer to the running line or improve stall margin.

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

1. A gas turbine engine comprising:
an output shaft configured for driving a load;
a power turbine drivingly engaged to the output shaft;
a boost compressor drivingly engaged by the power turbine; and
a boost compressor bleed air circuit having an inlet fluidly connected to the boost compressor and an outlet fluidly connected to the power turbine.

2. The gas turbine engine defined in claim 1, wherein the engine further comprises a core having an inlet fluidly connected to an outlet of the boost compressor and an outlet fluidly connected to the power turbine.

3. The gas turbine engine defined in claim 2, wherein the core includes a high pressure compressor, the high pressure compressor fluidly connected to the boost compressor, and a high pressure turbine drivingly engaged to the high pressure compressor.

4. The gas turbine engine defined in claim 3, wherein the core further comprises a combustor, the combustor having an outlet fluidly connected to the high pressure turbine, the high pressure turbine having an outlet fluidly connected to an inlet of the power turbine.

5. The gas turbine engine defined in claim 2, wherein the boost compressor bleed air circuit includes a diverting valve displaceable from a first position in which compressed air from the boost compressor is caused to flow to the core and a second position in which compressed air bled from the boost compressor is diverted into the power turbine.

6. The gas turbine engine defined in claim 4, wherein the boost compressor bleed air circuit includes a diverting valve configured to direct flow from the boost compressor either to the high pressure compressor of the core or to the power turbine.

7. The gas turbine engine defined in claim 6, wherein the boost compressor bleed air circuit is configured to bypass the core.

8. A turboshaft or turboprop engine comprising:
an output shaft,
a boost compressor;
a power turbine drivingly connected to the output shaft and the boost compressor;
a core including a high pressure turbine drivingly connected to a high pressure compressor, the high pressure compressor fluidly connected to the boost compressor for receiving pressurized air therefrom; and
a boost compressor bleed air circuit fluidly connecting the boost compressor to the power turbine, the boost compressor bleed circuit allowing the core to be selectively bypassed.

9. The turboshaft or turboprop engine defined in claim 8, wherein the core further comprises a combustor.

10. The turboshaft or turboprop engine defined in claim 9, wherein the combustor has an outlet fluidly connected to the high pressure turbine, the high pressure turbine having an outlet fluidly connected to an inlet of the power turbine.

11. The turboshaft or turboprop engine defined in claim 8, wherein the boost compressor bleed air circuit includes a diverting valve displaceable from a first position wherein pressurized air from the boost compressor is allowed to flow to the core and a second position wherein pressurized air bled from the boost compressor is injected into the power turbine.

12. The turboshaft or turboprop engine defined in claim 8, wherein the boost compressor bleed air circuit includes a diverting valve configured to direct flow from the boost compressor either to the high pressure compressor of the core or to the power turbine.

13. A method of operating a compressor section of a gas turbine engine having a boost compressor driven by a power turbine which also drives an output shaft of the engine, the method comprising: bleeding air from the boost compressor, and reinjecting the boost compressor bleed air into the power turbine.

14. The method defined in claim 13, wherein the engine comprises a core having a high pressure compressor in fluid flow communication with the boost compressor, wherein bleeding air from the boost compressor includes selectively diverting at least a portion of the air pressurized by the boost compressor away from the core for reinjection into the power turbine.

15. The method defined in claim 14, including selectively bypassing the core.

16. The method defined in claim 14, creating a variable flow cycle through the compressor section to allow the flow through the core of the engine to be tailored.

17. The method defined in claim 14, comprising varying a flow of pressurized air through the core by selectively diverting at least a portion of the air pressurized by the boost compressor into the power turbine.
